(19) United States
(12) Patent Application Publication
(10) Pub. No.: US 2013/0342349 A1
(43) Pub. Date: Dec. 26, 2013

(54) SYSTEMS AND METHODS FOR HAND HYGIENE COMPLIANCE

(71) Applicant: Nestor G. Cruz, Mississauga (CA)

(72) Inventor: Nestor G. Cruz, Mississauga (CA)

(21) Appl. No.: 13/528,459

(22) Filed: Jun. 20, 2012

(51) Int. Cl. G06Q 50/22; G08B 23/00

(52) U.S. Cl. 340/573.1; 705/2

(57) ABSTRACT

A method and system for controlling hand hygiene compliance in a health care environment is provided. Location identification tags in communication with sensors on hand hygiene instruments within a health care environment, are monitored to collect hand hygiene event data and to determine rates of hand hygiene compliance below set targets. Root causes of hand hygiene compliance are identified and corresponding hand hygiene solutions are provided to implement lean analytics and six sigma based improvement to hand hygiene compliance rates.

### FIELD OF INVENTION

This invention relates to systems and methods for hand hygiene compliance. More specifically, this invention relates to hand hygiene monitoring, detection, alerting, and improvement methods and systems of analytics and other methodology.

### BACKGROUND

Hand hygiene compliance is a serious issue affecting hospitals, clinics and other health care facilities. Worldwide, more than seven million people develop Hospital-Acquired Infections (HAIs) annually, and it is estimated that more than 80% of infectious diseases are transmitted by touch (Tierno, P. The Secret Life of Germs. Atria Books: New York, N.Y., USA. 2001). HAIs are the fourth leading cause of death in North America with direct costs of up to US$47 billion per year (Centers for Disease Control and Prevention. National Vital Statistics (2009)). There are over two million cases of HAIs per year in North America, each case resulting in direct costs of up to US$60,000 (Klevens R. M., Edwards J. R., Richards C. L., Horan T. C., Gaynes R. P., Pollock D. A., Cardo D. M. “Estimating Health Care-Associated Infections). Furthermore, patients with an HAI have a mortality rate up to five times greater than average. HAIs can also lead to infection outbreaks forcing hospitals to close wings, quarantine patients, incur legal costs and face damage to their reputation.

Patients who develop HAIs are likely to experience longer hospital stays—with the average length of stay for a patient with an HAI at about 22 days, while those without an HAI (adjusting for patient differences) have an average stay of about five days. Patients with HAIs also are much more likely to return to the hospital, with readmission rates at almost 30% for patients with HAIs, compared to just 6% for patients without this complication (Savage, B. et. al. The cost of health care associated infections. GE Healthcare IT).

Hand hygiene is thus an important practice in health care facilities and for health care workers and has a significant impact on reducing the spread of infections. By monitoring hand hygiene practices, health care facilities can help reduce HAIs in patients while receiving medical treatment.

The World Health Organization (WHO) has estimated that up to 70% of HAIs can be prevented by following proper hand hygiene compliance policies. However, a study found that most hospitals believe their hand hygiene compliance rate for staff is 70% to 90%, while the actual rate is well below 50% percent (Smith R L II, Sawyer R G, Pruett T L. Hospital-acquired infections in the surgical intensive care: epidemiology and prevention. Zentralbl Chir 2003; 128(12): 1047-106)).

The WHO has identified the link between HAIs and hand washing to be a global problem that should be addressed on national and local levels. Several factors can be attributed to HAIs. However, one of the leading causes has been found to be the hand washing conduct by staff who treat or work with patients and the lack of policies and enforcement around systematic hand washing by such staff. The Joint Commission, Centres for Disease Control and WHO have a variety of information and guidelines for hospitals to develop and manage hand washing policies. This includes the use of sanitizer as well as the more traditional soap and water methods.

Measuring Hand Hygiene Compliance (HHC) has traditionally been a very manual process consisting of periodic audits and studies which capture just a small portion of potential events, and with questionable accuracy.

The WHO Guidelines on Hand Hygiene in Healthcare, WHO Publications, 2009 lists a total of five moments where hand hygiene is required. These moments are: before patient contact; before an aseptic procedure; after body fluid exposure risk; after patient contact; and, after contact with patient surroundings.

It is estimated that anywhere from 30% to 70% of HAIs can be prevented by following hand hygiene compliance policies. As an example, one study found that a linear relationship exists between hand hygiene compliance and HAI rates. For each 1% increase in hand hygiene compliance, there is a 0.6% decline in the prevalence rate of the HAI Methicillin-Resistant Staphylococcus Aureus (MRSA) (The Boston Consulting Group and Wharton, University of Pennsylvania. Rethinking Lean: Beyond the Shop Floor. 2009).

A WHO study reported the adherence of health care workers (HCW) to proper hand hygiene as being very variable, with an overall average of 38.7% compliance, with mean baseline rates from 5% to 89%, and with numerous factors cited as influencing adherence to proper hand hygiene procedures (World Health Organization, Patient Safety, A World Alliance for Safer Health Care, WHO Guidelines on Hand Hygiene in Health Care: a Summary, First Global Patient Safety Challenge, Clean Care is Safer Care at Page 15 of 64, Paragraph 2.2).

A rapidly ageing North American population and the continuing financial stress on both government and industry, has created challenges in the health care industry. Significant cutbacks and cost-cutting measures in health care require health care providers to implement new solutions to improve patient care while at the same time cutting costs.

Despite budget constraints, health care facilities are accountable for delivering higher quality care with fewer medical errors and lower wait times. As a result, health care facilities require greater understanding and quantitative measurement of their people, processes, inventory and patients in order to meet these higher expectations on a constrained budget. This increased emphasis on continuous quality improvement is driving demand for new evidence-based methods to capture, monitor and report health care facility performance data. A strict emphasis on performance analytics and reporting has already been placed into law by policy makers, worldwide.

Improved hand hygiene compliance in hospitals is also motivated by government imposed changes. For example, Ontario's Excellent Care for All Act requires that performance based compensation be implemented for health care facility executives, with such compensation being directly linked to improvements and achievements. This factor provides further motivation to develop cost effective solutions to reduce medical errors, decrease patient wait times, improve tracking, of physical assets, tests and people, as well as reduce the incidence of HAIs.

In the U.S., fundamental legislative changes in the health care landscape, such as the recently passed Patient Protection and Affordable Care Act will dramatically increase demand for health care services as 40 million additional individuals become insured. Furthermore, the Hospital Inpatient Value-Based Purchasing Program (HIVBP) under Section 3001 of the Patient Protection and Affordable Care Act places a portion of virtually every hospital's U.S. Medicare reimbursement at risk if certain benchmarks are not met for performance on a range of quality and patient satisfaction measures. Beginning with 1% in fiscal year 2013 and growing incrementally to 2% in fiscal 2017, on average, U.S. hospitals may lose up to $750,000 annually, if performance measures are not met. Only a small number of hospitals will either keep their full reimbursement or perhaps gain some added reimbursement. If health care facilities maintain the status quo, most will lose significant amounts of revenue. Therefore, there is an increased demand for improved quality measures, such as hand hygiene compliance methods and systems.

Improving throughput in hospitals and medical care facilities will become a challenge, calling for better process efficiency and labour productivity at a time when most health care facilities seem to be already at the limits of their capacity. To meet these requirements, health care administrators are in need of innovative solutions to streamline processes, reduce cost, and report improvement metrics.

Current health care facilities' measurement systems have several limitations in their ability to provide immediate value to patients, administrators and staff. Some of the key issues in existing hand hygiene solutions include the following:

i) Measuring hand hygiene compliance has generally been a manual process consisting of periodic audits and studies which capture just a small portion of potential events, and with questionable accuracy. Manual hand hygiene compliance systems are unable to effectively apply lean-based process transformation methods, which require real-time feedback;

ii) current measurement systems are full of “blind spots” or areas within the patient process that are often difficult to capture with respect to hand hygiene compliance; and

iii) today's systems in health care facilities describe “after the fact” data and lack the capacity to identify, alert and prevent defects in process before they occur, rather than after. 95% of all hand hygiene data is descriptive in nature. Hand hygiene data is also generally “after the fact”, rendering it un-actionable (The Joint Commission Mission 2009, Measuring Hand Hygiene Adherence: Overcoming The Challenges, at page 29 of 232).

It can therefore be advantageous to provide a comprehensive and efficient apparatus, system, process and method that can increase hand hygiene compliance, for example, by use of automatic measurement, detection and alerting means, and that can provide real-time feedback. It can be advantageous to provide a system that continuously and automatically receives and processes hand hygiene compliance data, and distinguishes this data based on numerous moments, such as before and after contagion contact, or before and after entering a particular location.

There is also a need to sustain user behaviour change achieved through lean-based process transformation, in particular improved people-based processes. Current initiatives make use of technology to gather information on various health care facility processes, such as hand hygiene compliance. However, these measurement systems remain focused on data gathering, with no real integration with the process improvement initiative. Although several lean and six sigma procedures have been proposed in literature to improve quality and reduce costs, these procedures usually target implementation of lean and six sigma concepts in a manufacturing environment where process variables are specific, and can include the amount of product at the end of a manufacturing line or the amount of waste generated by a specific manufacturing method, and can readily be identified and modified to improve efficiency.

In a health care facility environment, people are the variables in processes such as hand hygiene compliance. It can be beneficial to provide a hand hygiene solution that uses lean or six sigma process improvement methodologies applied to the health care environment, to streamline operations, deliver better value to patients and improve profitability and sustainability in their operations. Further, it can be beneficial to use lean six sigma principles to measure hand compliance outcomes based on intermediate hypothesis, which can result in sustainable lean six sigma improvements to processes in the complex and dynamic health care environment.

It tends to be desirous, therefore, to have a comprehensive and efficient solution that sustainably increases hand hygiene compliance, for example, a technology-based hand hygiene compliance solution that enables health care staff and administrators to automatically monitor performance and compliance. Further, it can be beneficial to have a hand hygiene compliance solution that permits administrators to capture and use knowledge in real-time to implement more efficient hand hygiene protocols, and alert health care workers of their hand washing activities. Still further, it can be a benefit to have a hand hygiene compliance solution based-on improvement methodology, such as lean and six sigma process improvement methods, to continually decreases incidences of HAIs.

### SUMMARY OF INVENTION

In aspects of the present invention, there are provided systems and methods for controlling hand hygiene compliance in health care environments. In an aspect, hand hygiene compliance event data is received from one or more sensors associated with hand hygiene instruments communicating with identification tags. The rate of hand hygiene compliance is determined by comparing the hand hygiene compliance event data to target compliance rates and then determining one or more root causes associated with the rates of hand hygiene compliance that fall below the target compliance rates. Following root cause(s) determination, one or more hand hygiene solutions are identified as associated with the identified root cause(s), and provides these solution(s) to relevant health care worker(s).

The determining of hand hygiene compliance rates may be based on particular locations identified as being contaminated. The provision of solution(s) to relevant health care workers may be by alerts such as audiovisual warnings or messages to communication terminals of health care worker when rates of hand hygiene compliance fall below the target compliance rates. Such messages may include e-mail messages to computer terminals or text messages to mobile telephone devices.

The systems and methods may also provide for receiving further hand hygiene compliance event data from one or more sensors, in which the further hand hygiene compliance event data is associated with the identification tag after the hand hygiene solution(s) is provided to the health care worker(s); determining a further rate of hand hygiene compliance by assessing the further hand hygiene compliance event data against the target compliance rate; determining, if the further rate of hand hygiene compliance is less than the target compliance rate, another of the hand hygiene solution(s) and providing the another solution to the health care worker(s).

The solution(s) may be determined based on the application of Lean Six Sigma change in relation to the identified root cause(s).

### BRIEF DESCRIPTION OF DRAWINGS

For a better understanding of embodiments of the system and methods described herein, and to show more clearly how they may be carried into effect, reference will be made by way of example, to the accompanying drawings in which:

FIG. 1 shows an embodiment of a hand hygiene compliance system;

FIGS. 2A-2D show a further embodiment of a hand hygiene compliance system with front end, middleware and back end;

FIG. 3 shows a floorplan of a configuration of hand hygiene compliance system in use in a hospital;

FIG. 4 shows an operational flowchart of an embodiment of hand hygiene compliance method;

FIG. 5 shows a further operational flowchart of an embodiment of hand hygiene compliance method;

FIG. 6 shows a still further operational flowchart of an embodiment of hand hygiene compliance method;

FIG. 7 shows an approach workflow of the hand hygiene compliance method and system which is triggered when a HCW enters a contaminated area;

FIG. 8 shows a leave workflow of the hand hygiene compliance method and system which is triggered when a HCW exists a contaminated area;

FIG. 9 shows a flow diagram of the hand hygiene compliance system and method, relating to identifying contaminated areas;

FIG. 10 shows an overall operational workflow of the hand hygiene compliance system and method;

FIG. 11 shows a flow diagram of the hand hygiene compliance system and method's compliance reporting for behavioural change monitoring;

FIGS. 12A-12B shows a flow diagram of the hand hygiene compliance system and method, including lean analytics and six sigma methodology.

### DETAILED DESCRIPTION

It will be appreciated that for simplicity and clarity of illustration, where considered appropriate, reference numerals may be repeated among the figures to indicate corresponding or analogous elements or steps. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein.

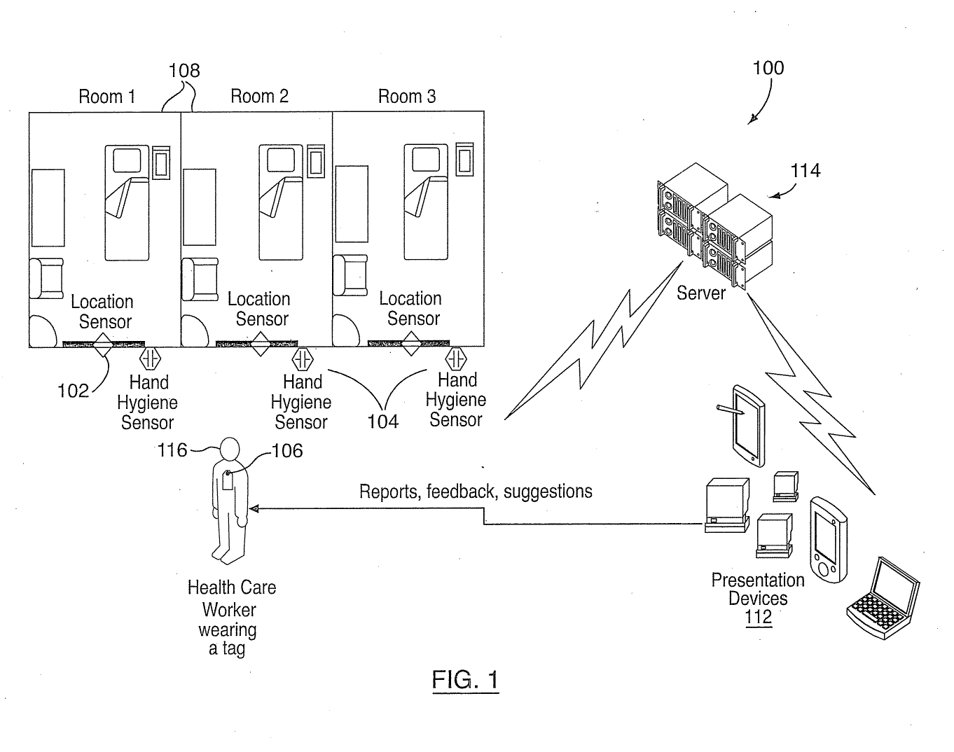

FIG. 1 shows an embodiment of hand hygiene compliance system 100. System 100 includes location sensors 102, for detecting entry or exit from specific hospital locations, such as patient rooms 108. Additionally, system 100 includes hand hygiene sensors 104, for detecting hand hygiene activity, such as hand washing, hand hygiene sensors being located at various locations including sinks 112 or other hand washing and cleaning stations, for example, sanitizer gel dispenser stations.

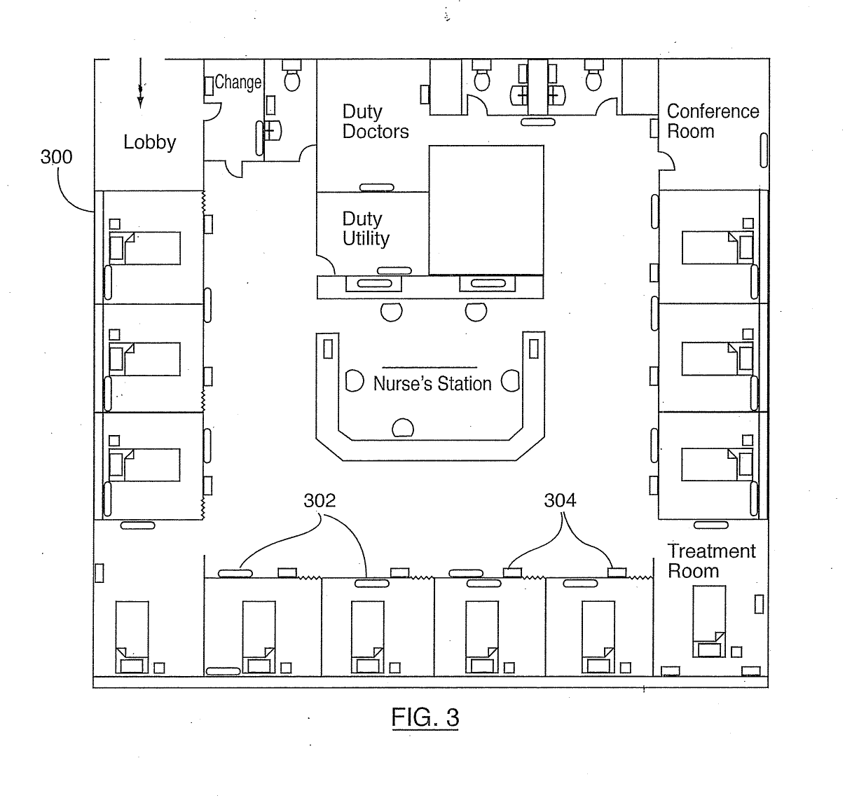

As shown in FIG. 1, location and hygiene sensors are strategically placed on the ceiling and on or near soap/alcohol dispensers located outside and inside patient rooms. FIG. 3 shows a hospital floorplan 300 with location sensors 302 and hand hygiene sensors 304 located at predetermined locations.

Health Care Workers (HCWs) 116 wear tags 106 which identify and transmit moments of hand hygiene compliance in real time. Persons of skill will appreciate that tags 106 and sensors 102 can utilize radio frequency, ultrasound, GPS, infrared or other types of location detection technologies. In the embodiment shown, HCW 116 may be nurses, doctors, nurse managers, department heads, infection control experts, and other types of hospital workers.

System 100 also includes interfaces 112 to provide compliance feedback to and from users, and to receive input. In some embodiments, the interfaces 112 are in communication with an analyzing determination engine which sets parameters for monitoring, detecting, and alerting on compliance. System 100 further comprises a server 114 consisting of a database for data and administration purposes. Although in the embodiment shown, a server is located on site to host the interface and analyzing determination engine components, system 100 may be distributed among several servers based on the expected load. Persons of skill will recognize that other server 114 components may be scaled accordingly.

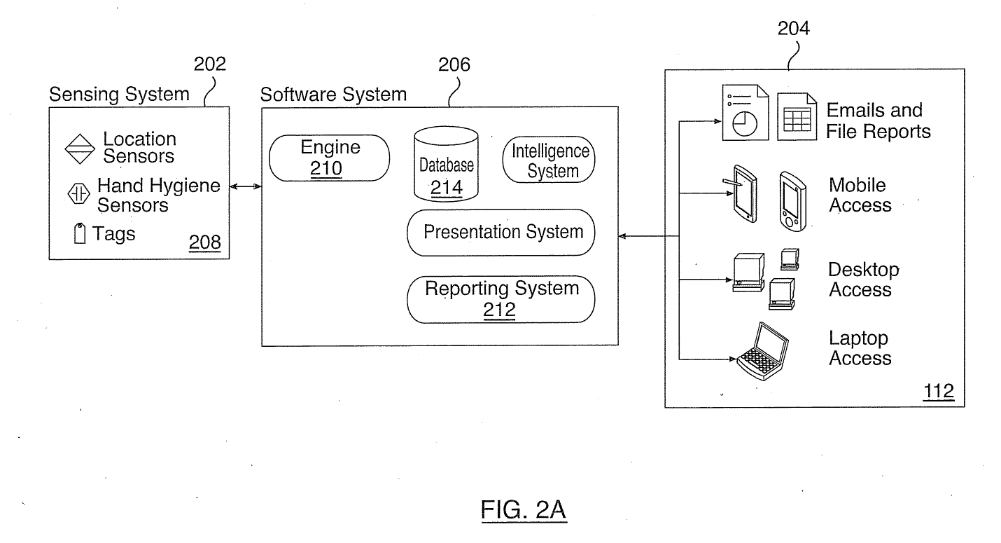

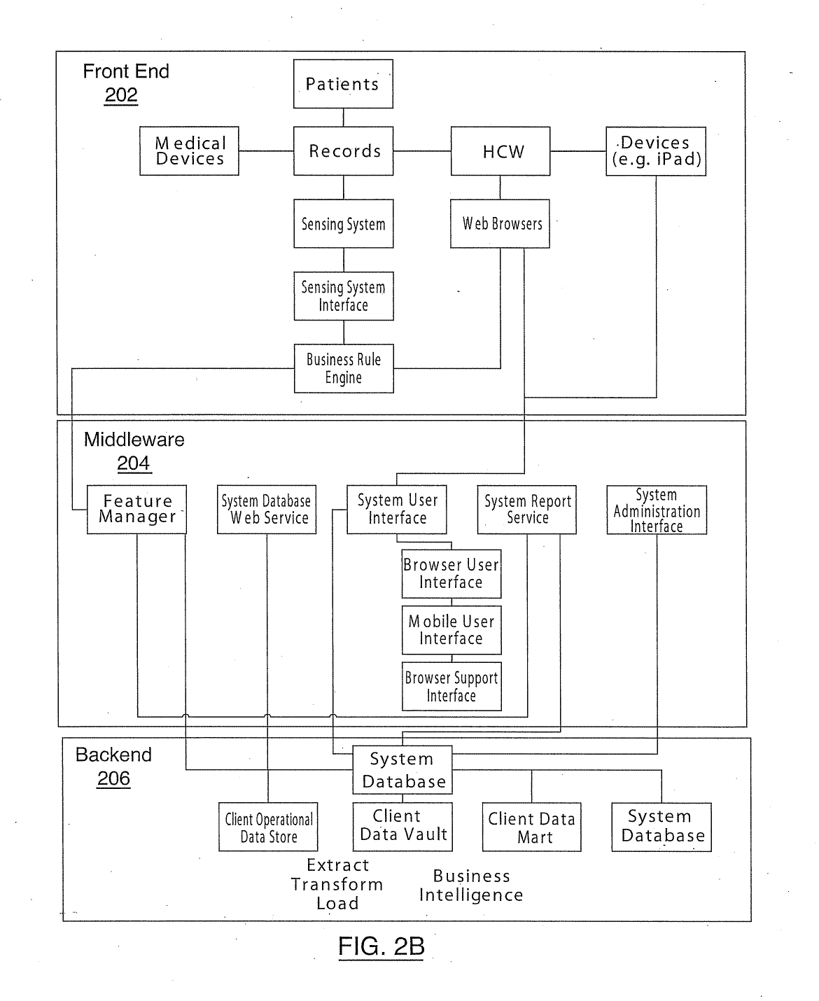

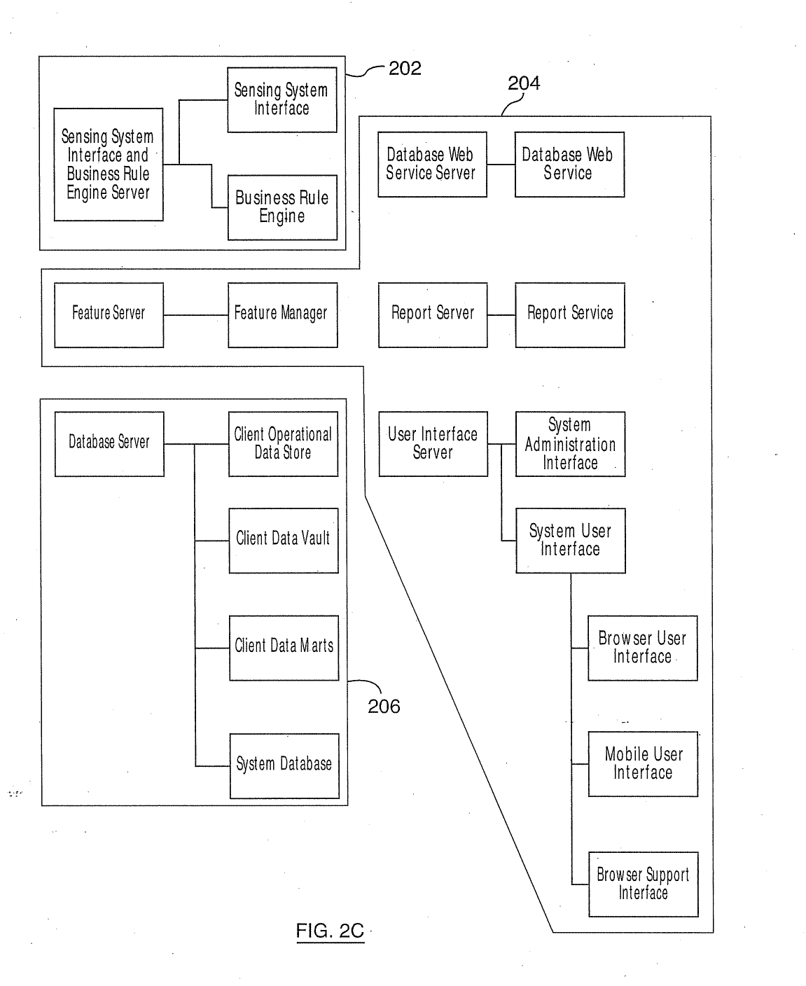

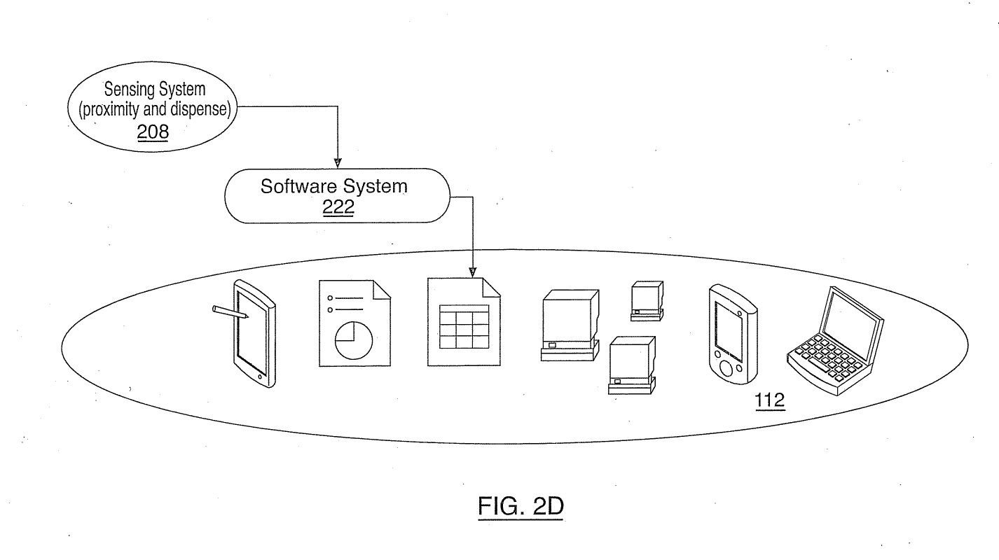

With reference to FIGS. 2 A-D, hand hygiene compliance system includes a frontend 202, a middleware 204 and a backend 206. Located at frontend 202 is the sensing network 208, which includes location sensors 102, hand hygiene sensors 104, tags 106.

Located at middleware 204 are the interface 112 components for feature management, which in some embodiments may allow administrators to control user access. In alternate embodiments, system 100 may include a database web service as a means for inputting and outputting actions and events onto system 100. Persons of skill will appreciate that interfaces may include laptops, mobile hand held devices, smartphones, printers, and other input and output devices. Further, interfaces 112, may be split depending on the client device and action. Further, a separate or second user interface may be provided for support and administration activities.

Located at backend 206 is database 214 and software system 222. In some embodiments, distributed databases can be used, which may include multiple databases split per client or per site and an overall system database for common data and administrative purposes. Persons of skill will appreciate that additional databases can be added to properly store processed information for the purpose of improving performance. Furthermore backend 206 may include analyzing determination engine 210 which manages parameters for actions and events onto the system, as well as report tool 212 for generating feedback to users. Persons of skill will appreciate that locating analyzing determination engine 210 at the health care facility, may reduce network latency issues.

As will be understood by persons of skill, as shown in FIGS. 2A-D, several additional tools and elements such as various servers, data repositories and interfaces, can be used for networking and communication between the front end 202, middleware 204 and backend 206.

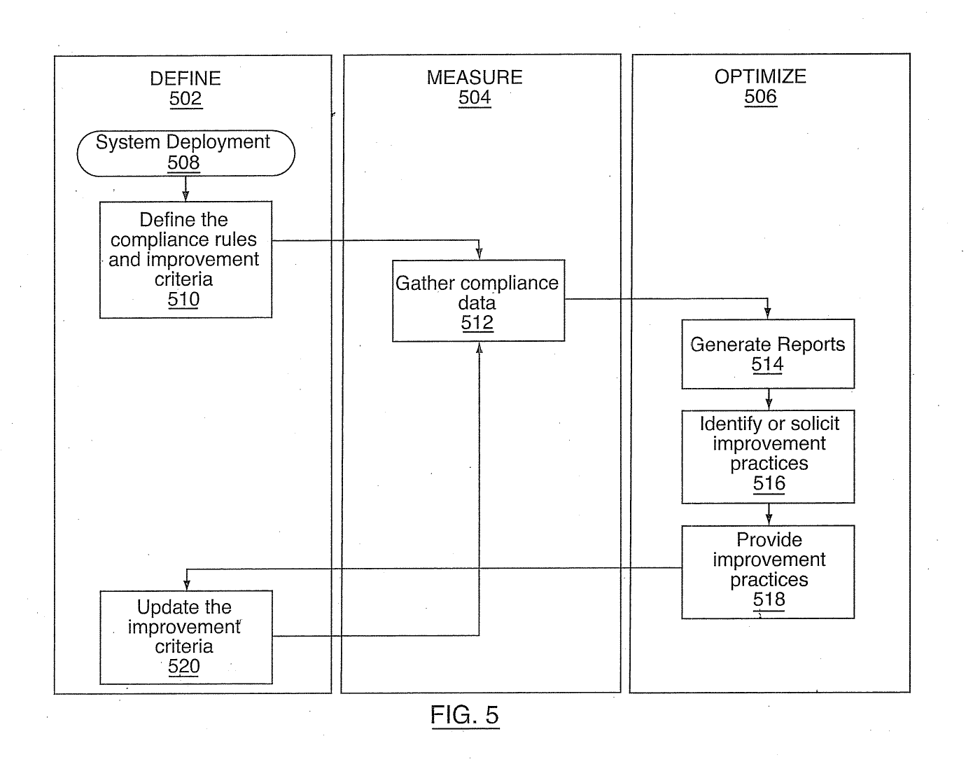

With reference to FIG. 5, an operational flowchart of hand hygiene compliance method 500 is shown, which in the embodiment exemplified displays three steps and focuses on continuous improvement of hand hygiene compliance. Define 502 is the first step in method 500 and involves system deployment 508, and determining the processes and behaviours that require change, by defining the compliance rules and improvement criteria 510. Measure 504 involves quantifying these processes and behaviours and providing real-time actionable data. In this aspect of the method, compliance data is gathered in step 512. Optimize 506 involves the provision of real time data feedback for continuous improvement and ongoing process transformation through technology enabled systems. In this step, reports are generated at 514, improvement practices are identified and solicited at 516 and improvement practices are provided at 518. As shown in FIG. 5, the improvement criteria is continually updated in an iterative manner at step 520 to allow for continuous improvement.

At define 502, systems and methods identify moments of hand hygiene that leverage lean six sigma and continuous improvement methodology. In some embodiments, these moments may be qualified based on the four moments set by the Government of Canada and adapted from the WHO, as follows:
1. before initial patient/patient environment contact;
2. before aseptic procedure;
3. after body fluid exposure risk; and
4. after patient/environment contact.
   Persons of skill will appreciate that parameters such as the percentage of compliance moments over the number of opportunities, may be set by a user or the system, and adjusted depending on observed data output factors.

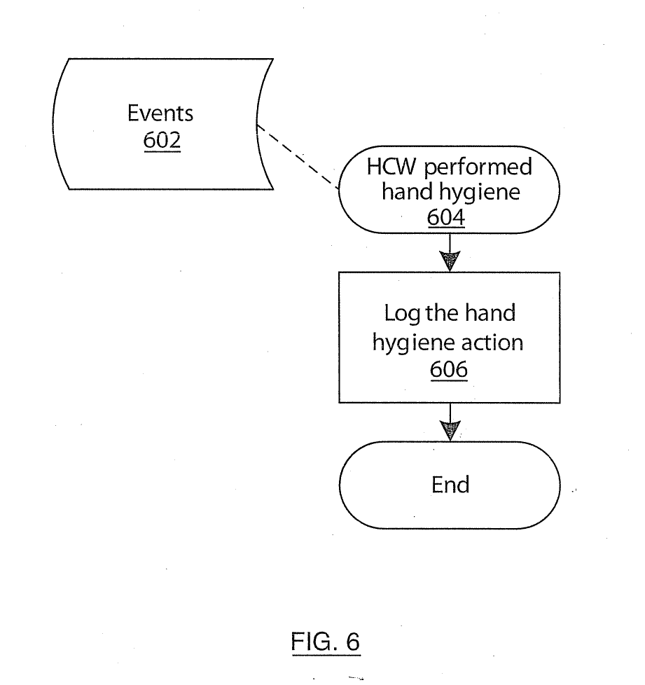

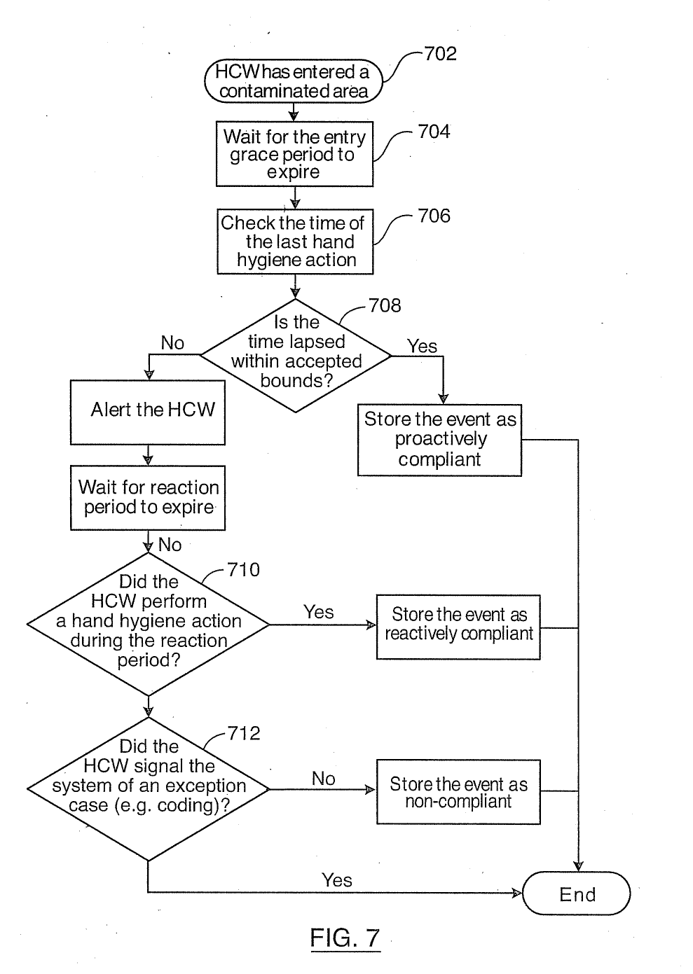

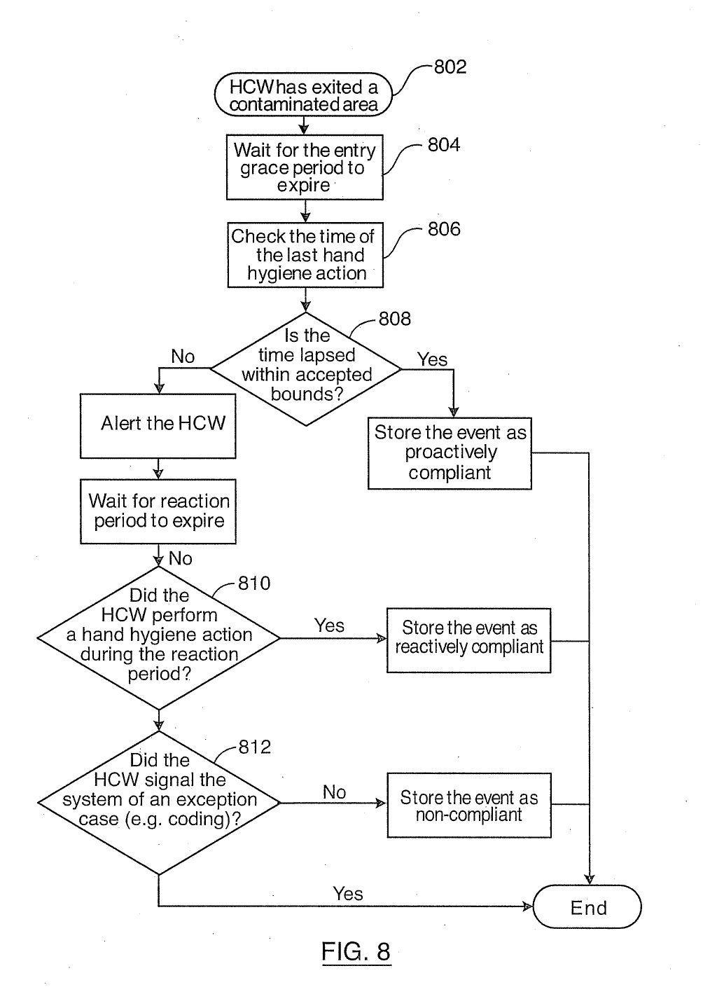

At measure 504, moments of hand hygiene are recorded by the system, with the use of the sensors, to gather compliance data at step 512. As shown in FIG. 6 the hand hygiene compliance method and system, first identifies a hand hygiene event 602, then identifies whether the HCW has performed hand hygiene 604 and logs the hand hygiene compliance or non-compliance 606. This hand hygiene process flow is triggered when the HCW performs a hand hygiene event 602. This event is logged by the system and is a parameter for the approach workflow 700 and leave workflow 800 shown in FIGS. 7 and 8, respectively.

The system and method of the present invention is able to distinguish between different moments. FIGS. 7 and 8 display flowcharts of the method beginning at the moments of entering a contaminated area 702 and exiting a contaminated area 802, respectively.

Sensors 102 and 104 identify hand wash activity and movement, and record missed opportunities to wash hands. Location sensors in combination with the tags 106 identify HCW 116 location. For example, when HCW 116 approaches a patient's room, location sensors located on the ceiling and by the soap or alcohol dispensers would detect HCW 116 presence. By placing location sensors at the entry and exit of rooms, for example, the system and method enables administrators to distinguish between events and to continuously receive and process hand hygiene compliance data based on a combination of moments, such as the moment before initial patient or patient environment contact and the moment after patient or environment contact.

Hand hygiene sensors 104 then assess whether or not HCW 116 fails to perform the hand hygiene, such as washing his or her hands inside and outside the room. This data is used to identify failure points.

Skilled persons will appreciate that sensors may record the following hand events:
HCW 116 washes his or her hands outside the patient room;
HCW 116 enters the patient room;
HCW 116 washes his or her hands with soap or alcohol in the patient room and puts on gloves if required;
HCW 116 performs intended actions, for example, assessment, dress changes, medication, wound cleaning, bathroom assistance, or other actions;
HCW 116 washes his or her hands with soap or alcohol in the patient room after performing the intended actions;
HCW 116 leaves the patient room; and
HCW 116 washes his or her hands outside the patient room.

With reference to FIGS. 7 and 8, approach workflows 700 and leave workflow 800 are shown. In the embodiment shown, approach workflow 700 is triggered in step 702 when a predefined event has been detected by the sensing system, for example, when HCW 116 has entered or come in contact with an entity labeled as contaminated by system 100. In some embodiments, a grace period, shown in steps 704-706, may be implemented. As displayed in steps 708, system 100 checks all previously recorded hand hygiene events and determines whether the required event, such as washing, was done within configurable time bounds. If yes, HCW 116 is considered clean and compliant for the moment before initial patient or patient environment contact. If no, system 100 sends an alert to HCW 116 informing the staff that they have entered a contaminated area and they must perform hand hygiene. In some embodiments, hand hygiene system 100 may activate an audible warning or visual light signal emission notification, allowing HCW 116 to comply before recording non-compliance.

In some embodiments, system 100 may be configured to allow HCW 116 to interact with system interfaces 112 to select a pre-defined course of action. For example, HCW 116 may choose to perform hand hygiene, ignore the alert or signal to the system that an exception case is occurring (e.g. coding). If HCW 116 chose to perform hand hygiene, in step 710, HCW 116 is logged as reactively compliant. If HCW 116 ignored the alert, HCW 116 is logged as non-compliant.

The hand hygiene compliance system and method of FIGS. 7 and 8 also includes an override feature. This override feature, shown in step 712, allows HCW 116 to justify exceptional cases where hand hygiene is not possible and non-compliance should not be recorded by the system. If an exception case was signaled by HCW 116, no compliance events are logged. For example, in the case of a high emergency patient code, performing hand hygiene is not practical given the urgent nature of the intervention. In such a case, HCW 116 receiving the automatic reminder may turn-off the reminder to avoid interference with the emergency care. Such instances are then justified in the software to reflect the appropriate rate of compliance.

Similar to approach workflow 700, in the embodiment shown leave workflow 800 is triggered when a predefined event has been detected by the sensing system, in step 802, for example, when HCW 116 leaves a contaminated area. In some embodiments, a grace period may be implemented in steps 804-806. As shown in step 808, system 100 checks all previously recorded hand hygiene events and determines whether the required event, such as washing, was done within configurable time bounds. If yes, HCW 116 is considered clean and compliant for the moment after patient or patient environment contact. Otherwise, system 100 sends an alert to HCW 116 informing the staff that they are leaving a contaminated area and they must perform hand hygiene. In some embodiments, system 100 may be configured to allow HCW 116 to interact with system interfaces 112 to select a pre-defined course of action. For example, HCW 116 may choose to perform hand hygiene, ignore the alert or signal to the system that an exception case is occurring. If HCW 116 chooses to perform hand hygiene, in step 810, HCW 116 is logged as reactively compliant. If HCW 116 ignored the alert, HCW 116 is logged as non-compliant. If, as indicated by step 812, an exception case was signaled by HCW 116, no compliance events are logged:

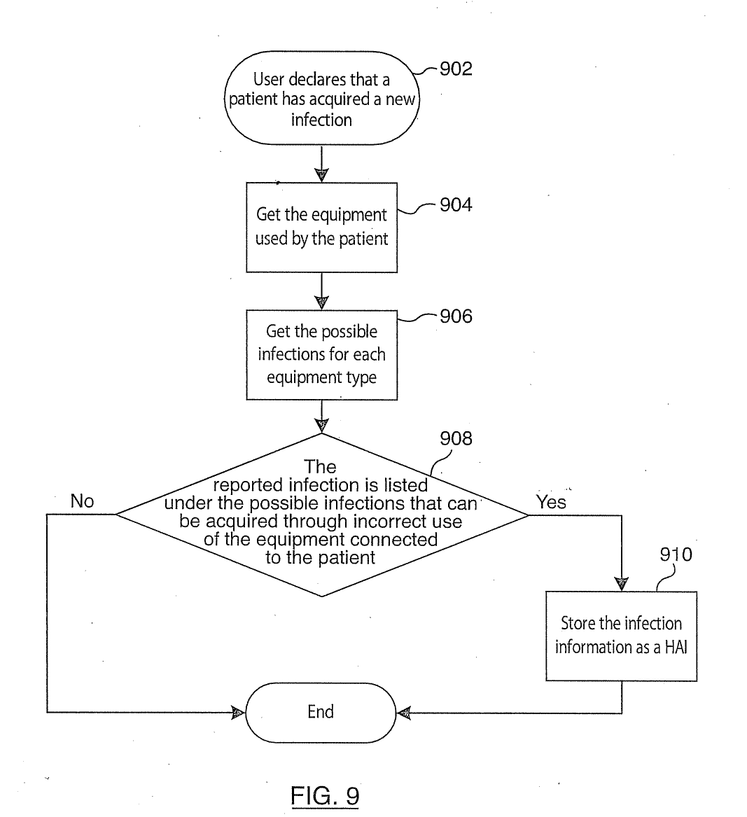

With Reference to FIG. 9, a flow diagram showing computing of infections is displayed, which provides a method for identifying contaminated areas. Skilled persons will appreciate that not all reported patient infections are considered to be HAIs, and that the hand hygiene compliance method distinguishes between HAI type infections and non-HAI type infections based on pre-determined or user configured parameters. In the embodiment shown, after a user identifies that a patient has acquired an infection in step 902, for example, the system identifies the type of equipment used by the patient in step 904, as well as the possible infections associated with the equipment in step 906. An HAI is positively identified in step 908 only if the infection can be caused by incorrect equipment usage, and can be transferred from the HCW. If an HAI has been identified, data such as patient location is stored in the system in step 910.

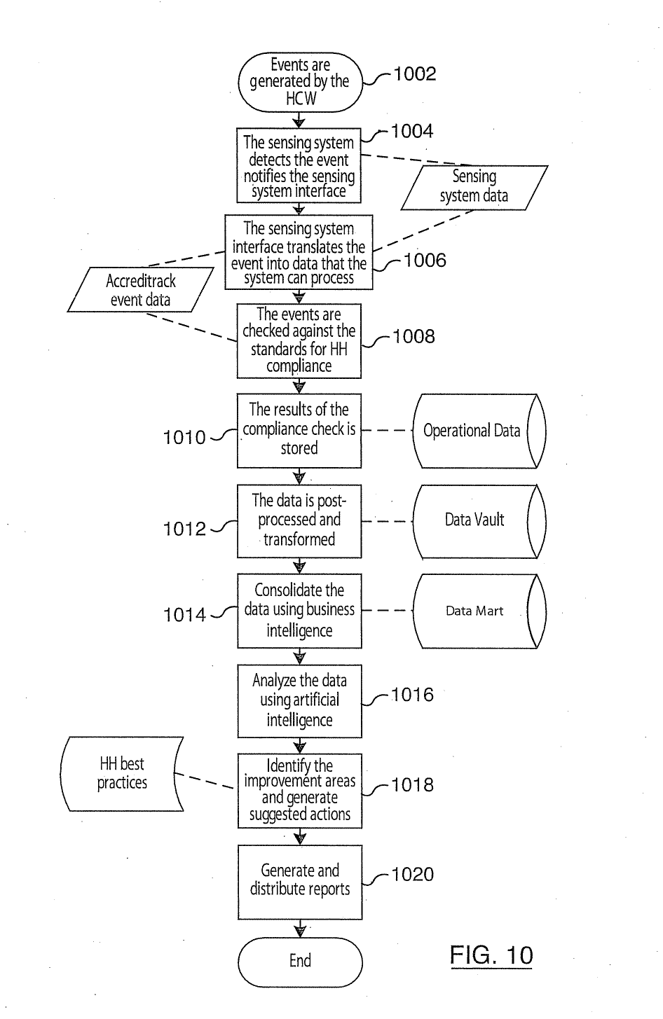

As shown in the operational workflow of FIG. 10, events performed by HCW 116 are detected by the sensing system at step 1002 to 1004. Such events may include, for example, HCW 116 movement or soap dispenses. At step 1006, each event is translated by the sensing system interface into a format that is understood by the hand hygiene compliance system 100. At step 1008, compliance checks are then used to check the actions against the expected standards. The results are stored at step 1010 and corresponding extract, transform, load processes are applied at step 1012 to generate a more manageable and maintainable data set. The new data set is then subject to intelligent processing at step 1014 to consolidate and extract operation critical information. At steps 1016 and 1018 this information is further analyzed by the system to identify key weaknesses and improvement areas'. At step 1020, using a database of hand hygiene best practices, reports are distributed containing the critical measurements and metrics, a list of improvement areas and suggested actions to further improve overall compliance.

In some embodiments, hand hygiene compliance reports may be stratified by the following criteria: per room; per user identification (ID); per user type (nurse, doctor, auxiliary, housekeeping, dietary, etc.); per department; per time of day; per day of week; per week of month; per month of quarter and quarter of year; per moment; per overall compliance; per sample reports; per type of compliance overtime, such as day, week, month, quarter, year; per proactive compliance (compliance without reminder); per reactive compliance (compliance upon sending of reminder); per overall compliance (proactive plus reactive compliance divided by number of hand hygiene opportunities) and per non-compliance (no recorded hand-washing after predetermined time has lapsed and reminder has been sent); and each type of stratification may be cross-referenced. Persons of skill will appreciate however that other report stratification criteria may be used.

Compliance reports can be generated real-time, daily, weekly, monthly, quarterly, yearly, and inclusion dates may be indicated (start and end dates) and can be generated on a number of multi-media and hardware types, for example, laptop computer, desktop computer, iPad, smart phone, LCD, LED TV, etc. Persons of skill will understand that other hardware or devices can be used to generate and display reports.

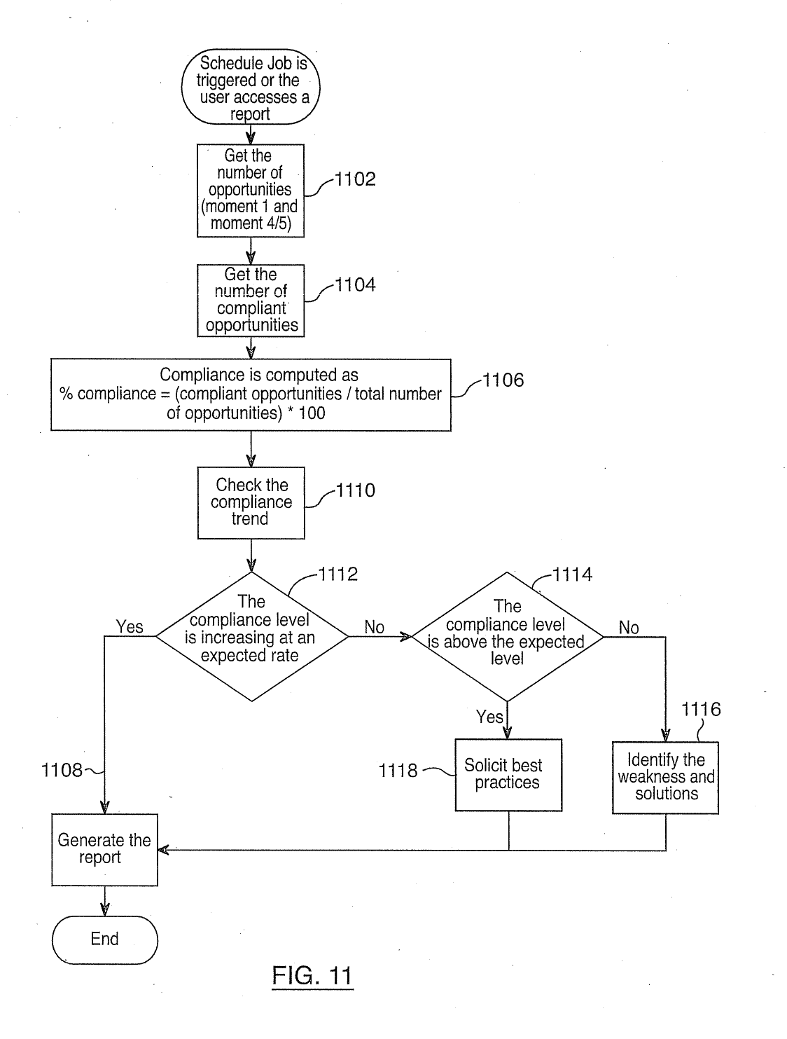

HCWs can access and extract reports for management or regulatory requirements that are generated by the system. Persons of skill will understand that necessary security access for generating reports can be granted based on the HCW's level of user role and responsibility stored in the system. FIG. 11 shows a flow diagram of the compliance reporting for behavioural change monitoring. In the embodiment of FIG. 11, compliance is computed in step 1102-1006 as a ratio of the number of compliant opportunities to the total number of opportunities. The computed compliance is checked against the compliance trend or goal at 1110. The system also checks whether the compliance level is increasing at an expected level at 1112 and if it is above the expected level at 1114. In instances where the compliance level is below the expected level, weaknesses and solutions are identified at 1116. In instances where the compliance level is above the expected level, best practices are solicited and identified 1118. Based on this data, reports are generated to display compliance details in step 1108.

In other instances, users' rates of proactive compliance may be compared, to their rates of reactive compliance. Over time, goals are set and implemented and trends established for reactive compliance percentage changes. These goals may be preconfigured or input by users and administrators. In some embodiments, the system can compute compliance trends based on predefined levels where level 1 occurs when 20% or less of compliance is proactive, level 2 occurs when 40% of compliance is proactive, level 3 occurs when 60% of compliance is proactive, level 4 occurs when 80% of compliance is proactive and level 5 occurs when at least 90% of compliance is proactive) and displayed on the report. Persons of skill will appreciate that such compliance parameters and goals can be structured differently depending on the particular needs of the users.

In still further embodiments, the system provides auto-notification reports based on a determined frequency (daily, weekly, monthly, and quarterly). These reports can be sent to HOW users or administrators through a variety of means including but not limited to email, SMS, and MMS communication protocols.

The system and method of the present invention perform process analytics and business intelligence on processed data using six sigma improvement and lean analytics philosophy. The system lists areas of improvement, which are highlighted for administrator awareness and action. In some embodiments, these items are automatically captured by the system in a critical care dashboard report. The system checks which items fall below the set compliance target. For example, if the target set for a period is 65%, the system generates a list of users with compliance below 65% and displays it in the critical care dashboard. The list remains on the dashboard until performance is consistently improved.

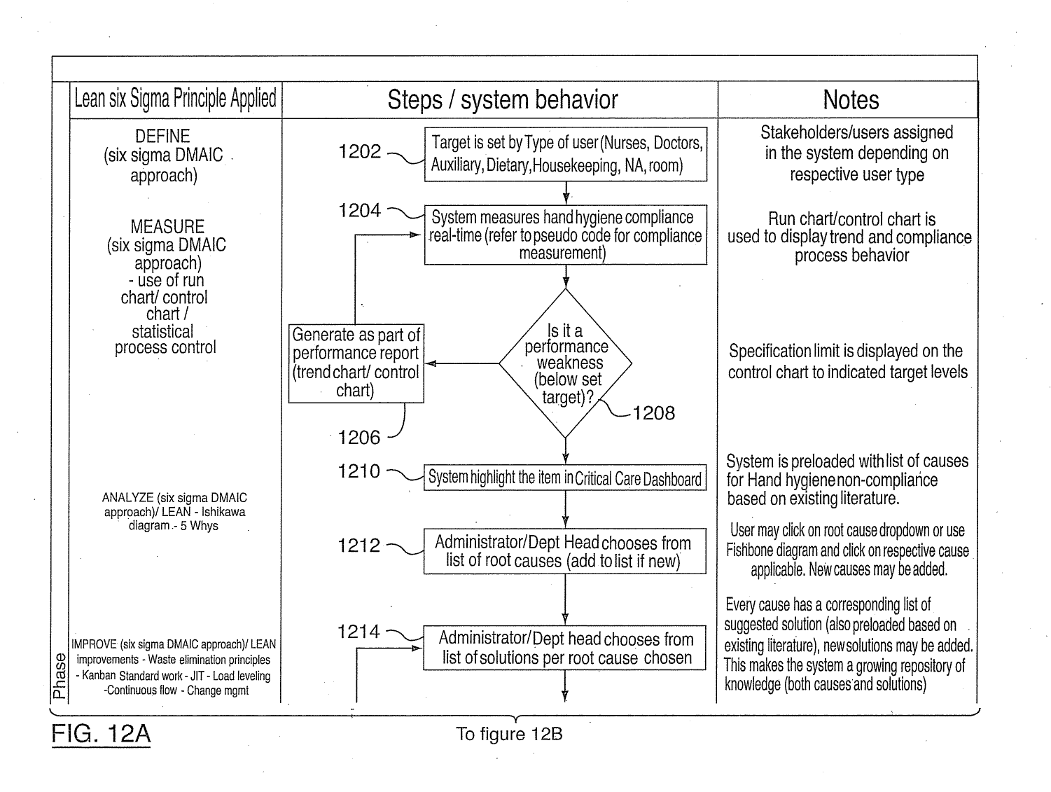

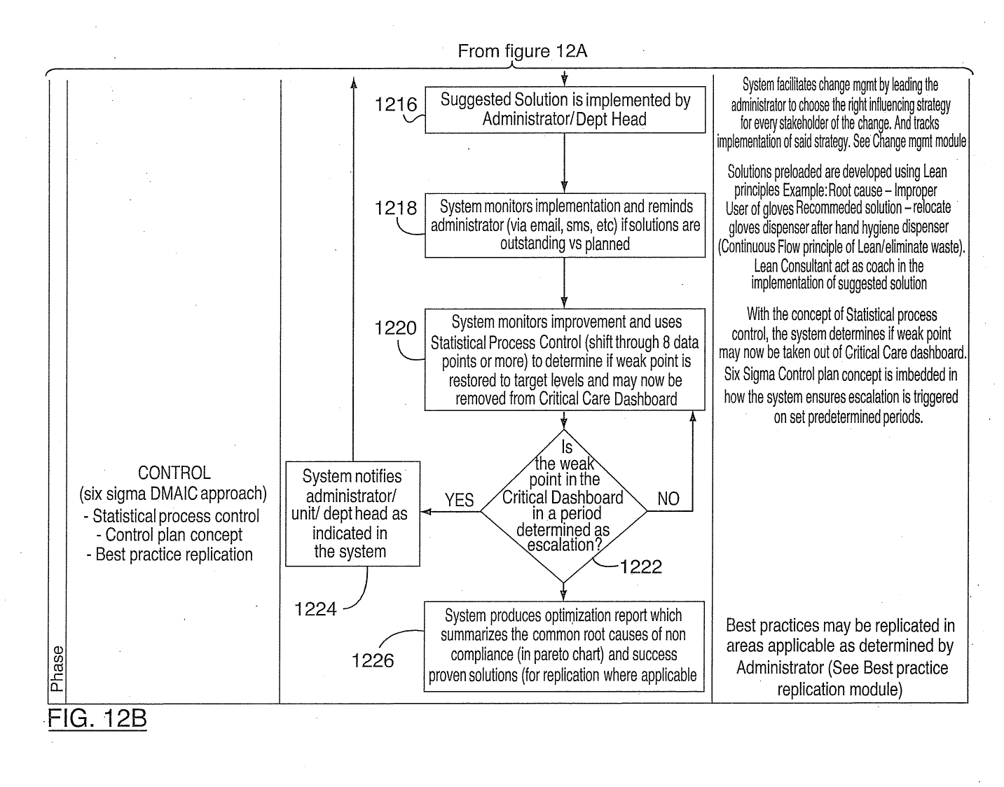

FIGS. 12A-12B shows a flow diagram of hand hygiene compliance system and method based on lean analytics and six sigma methodology. In step 1202 a compliance target for the user is set based on the user type, which may be nurse, doctor, auxiliary, dietary, and housekeeping. The compliance target may also be set by room location, in some embodiments. In step 1204, the system measures the user's hand hygiene compliance real-time. The system then checks in step 1208 whether the compliance is below the set target. This information is generated as part of a report used to display trend and compliance process behavior in step 1206. Target levels are also displayed on generated reports and charts. If the performance is below the target, the system highlights the item in a critical care dashboard output, located on interfaces, in step 1210.

A list of root causes, pre-loaded on the system as root causes of hand hygiene non-compliance is displayed for administrators and users to view in step 1212. Users and administrators may add to the repository of root-causes in the system. Users and administrators may select root causes, from the displayed list, as shown in step 1214. In some embodiments, the system may automatically identify appropriate root causes. Every root cause has a corresponding list of suggested solutions, which in some embodiments are also pre-loaded on the system, or may be added to by users and administrators of the system. The appropriate solution is implemented in step 1216, and the system monitors implementation and reminds users and administrators of outstanding solutions, in step 1218. Such reminders may be in the form of email or SMS, for example, although skilled persons will appreciate that different means of communicating reminders may be implemented.

As shown in step 1220, the system monitors improvement and uses statistical process control, to identify hand hygiene compliance data above target levels and to remove these items from the critical care dashboard. Six Sigma methodology is imbedded in the system to ensure that the appropriate parties are notified if items remain below targets, as shown in steps 1222 and 1224. If non-compliance continues, the system reiterates the root cause and solution steps described in steps 1214-1220, to restore the item to below the compliance target. The system also produces optimization reports in step 1226 which summarize the common root causes of non-compliance and successful solutions, for replication, where applicable.

As stated above, in some embodiments, critical care data is presented together with a set of solution recommendations tied to a root cause. A check is then performed between the solution or course of action and a growing repository of improvement solutions, and the solution or course of action is added to the list if not already present. For example, the system may be preloaded with a list of common causes of hand hygiene non-compliance and recommended lean six sigma based solutions of every root-cause to be selected. Persons of skill will appreciate that such causes are based on existing literature of hand hygiene data available. In some embodiments, a common root-cause is selected, to generate a list of recommended actions, which they may use. In still further embodiments, root-causes and recommended actions not pre-loaded in the system can be added by users. As such, the system becomes a growing repository of causes and solutions and becomes a knowledge repository in itself.

The embodiment shown can contain a change management module in which the stakeholder can be selected. In such embodiment, an appropriate solution strategy is chosen from the list of generated solutions, for example, one-on-one coaching, group training, email communication or management directive, together with the determined users and parties to perform the strategy. In some embodiments, the status of an action is also indicated and monitored through traffic light indicators versus target dates indicated. For example, green may correspond to a completed status, yellow to an in progress status and red to a delayed or not started status.

Embodiments of the system can include several different types of notification protocols. In some embodiments, the system includes an auto-escalation module that sends auto-notifications to administrators when an item is marked as critical care for particular time periods. These periods, can be set for example, to send notifications if an item is in critical care for longer than 3 days, for 1 week, for 2 weeks, and daily after 2 weeks. In some embodiments, items moved into the critical care dashboard are monitored and remain on the dashboard until the measure has improved. When the item has returned to its expected level of performance consistently equal to or above set targets, the item in critical care can automatically move out of critical care dashboard.

In further embodiments, optimization reports are generated that include common root causes of performance decline and solutions which have been deemed effective in addressing the root causes.

In still further embodiments, the system includes a best practice sharing module, which assesses successful solutions and applies these to solutions to other problem areas. For example, with this module, the targeted area is indicated, together with the users and HCWs involved, and status (communicated, replication in-progress, replication complete). In such embodiments, an auto-notification email reminder is sent to the person in charge if the status remains the same (except in the event of replication complete status) after 1 week, 2 weeks, 3 weeks, 4 weeks, daily after the 4th week.

In other embodiments, the system includes a critical outcome module that correlates infection rate and hand hygiene compliance. Through this model, the system computes the infection rate based on a formula and data on infection incidents entered by practitioners. A correlation with hand hygiene compliance can be reported and generated. The infection rate may be calculated, for example, based on the Centers for Disease Control and Prevention and World Health Organization formula which is Number of Infections/Number of Patient Days. The number of infections, the type of infection and number of patient days may be entered into the system by the Infection Control team at the hospital.

In further embodiments, the system includes an outbreak investigation assistance module. When the module detects that an outbreak has occurred, critical compliance details are generated on the rooms involved in the outbreak, to assist in an investigation. For an investigation, the report may filter the data for room, date, time and the users who entered the area. In some embodiments, the system also triggers a notification, which may include for example, an email or SMS when a potential outbreak pattern is formed. The outbreak pattern may, for example, be based on the Ontario Ministry of Health and Long-term care thresholds, as follows:

for wards/units with 20 beds, 3 cases of nosocomial infection identified on one ward/unit within a seven day period or 5 cases within a 4 week period;

for wards/units with <20 beds, 2 cases of nosocomial infection identified on one ward/unit within a seven day period or 4 cases within a 4 week period;

baseline infection rate for two months is at or above the 80th percentile for comparator hospitals; or

infection rate is greater than or equal to 2 standard deviations above the baseline.

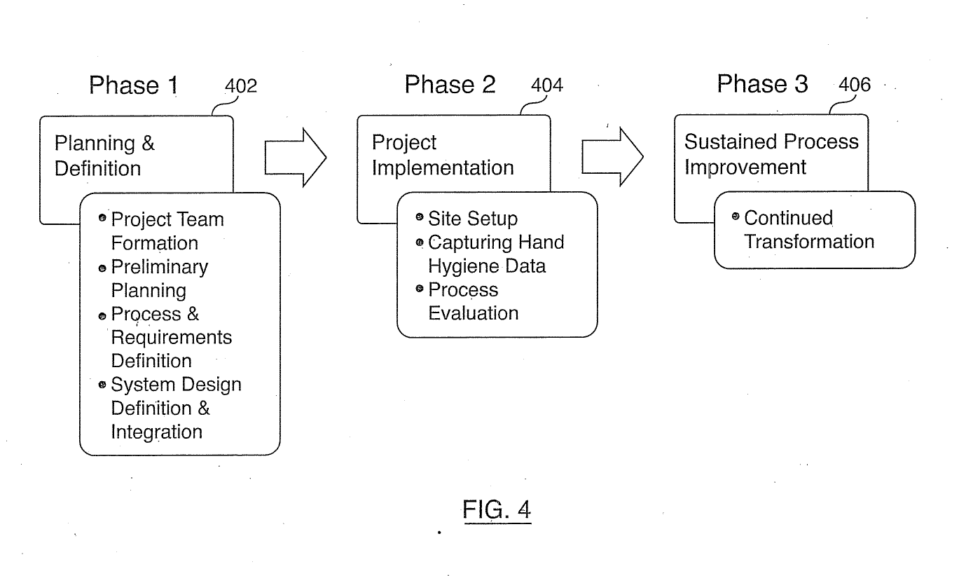

FIG. 4, shows an operational flow diagram of hand hygiene compliance method 400 in use. Method 400, can be used for planning and definition of hand hygiene requirements, as well as project implementation whereby sensing devices and computer systems apply lean and six sigma principles to the health care environment to define, measure, and act upon data with respect to present state and future state of hand hygiene compliance, using an improvement enabling computing system, such as described herein, to make or support actions or decisions. Furthermore, the hand hygiene compliance system exemplified herein can be used to implement sustained process improvement by continued real-time measurement and ongoing transformation.

As shown in FIG. 4, hand hygiene compliance system and method can assist health care administrators to achieve performance goals and can lower costs of health care, improve patient care and monitor compliance. In use, the system and method includes a number of phases. Phase 1, shown in element 402, includes planning and definition, such as project team formation, initial data gathering, determining the current and “next state” processes, as well as finalizing overall solution design.

Phase 2, shown in element 404, involves project implementation, such as deployment of the solution to the client site, hardware and software setup and configuration, capturing hand hygiene data, as well as reassessing and improving “next state” processes. Project implementation includes all the processes and steps involved in ensuring that the software and hardware are operating properly in its environment, including installation, configuration, testing, up to sign-off and turnover to the client health care facility. In the embodiment shown, this phase commences once all required design documents are approved by the health care facility.

Phase 3, shown in element 406, involves sustained process improvement, including a continuous cycle of improvement leading to achievement of set targets. In this phase, sustained process improvement means the provision of services and support to the health care facility once project implementation completes and the solution has been turned over to the health care facility staff.

Phase 1 402, shows the project team formation step. Persons of skill will appreciate that in some embodiments team formation can be implemented by software based algorithms that assign user roles based on stored user skills. For example, a team leader can be assigned to monitor the project and manage tasks from various stages such as fact-finding interviews with the health care facility's administration to post-implementation phases of continued compliance monitoring. In use, a user identified as a team leader may be responsible for meeting with health care administrators to define desired outcomes and to establish the responsibilities of various users. The team leader or the system may identify working relationships of users, the communication and notification processes between users, as well as deliverables and timeframes in order to ensure successful implementation of the system.

Project managers are then identified by the system, to select resources to execute the various components of the project, and to identify contacts and resources. In operation the project managers are responsible for planning, coordinating, and managing the project from inception to completion, supervising the project's requirements and ensuring completion, on time and within budget, and to implement quality standards.

The project team can be selected to comprise individuals skilled in project management, software programming lean and six sigma process transformation philosophy, and hardware installation and maintenance for the sensing system. In some embodiments user skills can be stored on the system to assist in user role assignment. The project team in some embodiments can be composed of representatives from information technology, as well as from units in the health care facility which are involved in or affected by the project.

Personnel can be assigned to setup, implement and deploy the sensing system and software in the health care facility at physical locations, and to conduct training of personnel on using, administering, and maintaining the solution. In some embodiments personnel can be assigned to provide post-implementation support to the health care facility on the software and hardware installed in the health care physical location, and to conduct direct observation and interviews, identify the current hand hygiene process, utilize lean-based process transformation to define a future process and identify improvements based on data gathered during the implementation.

An implementation and deployment team is also selected to comprise health care platform experts, network infrastructure experts, hardware experts; and sensing hardware experts. In the embodiment shown, this team is responsible for working with the health care facilities delegates, on-site, to identify a possible solution. The team can be composed of software and hardware specialists, who install and set up the software and the sensing system, and verify or check that the software and hardware is running correctly in order to meet agreed-upon compliance monitoring requirements.

In the embodiment shown, a support team is selected to comprise network hardware and sensing system experts and provide continued timely support to the health care facility once project implementation completes by providing troubleshooting, software and hardware maintenance skills as needed by health care facility staff.

A process transformation team can be selected to comprise lean and/or six sigma practitioners with expertise in the health care industry who are responsible for helping the client health care facility identify the current and the desired processes. The team may use various methods to gather information and identify the current process followed by the health care facility, as well as the desired future process. The team may then conduct verification workshops to present the team findings and finalize the desired future process. The team may then coordinate with the implementation and deployment team to ensure that the process is properly set up and the data measuring points identified and the sensing system installed appropriately to monitor the process effectively and accurately. The team can also ensure that the desired process is communicated properly to health care facility staff. The team may then monitor the data and analyze the effectiveness of the proposed process. Improvements may be proposed and implemented with the concurrence of the health care facility team and with the assistance of the implementation and deployment team.

A health care facility team can be selected to identify key personnel responsible for providing facility data and for ensuring that business requirements are identified, documented and included in the implementation. A representative may be selected from a department, within the health care facility, that will be affected by the outcome of the project. This representative may be involved from the start of the project, and may define the project with the project manager. Once the project has been launched, this representative may participate in regular reviews of the project's progress, and timely identification and resolution of issues or roadblocks. The representative can also be responsible for ensuring that the objectives and benefits of the project are accurately communicated to the health care facility's senior and other members of management who have a significant interest in the project's outcome, and other project stakeholders.

In the embodiment shown, the health care facility representative, project team, project manager, and implementation and deployment teams meet regularly to coordinate project activities, communicate issues and their resolution, and work to facilitate speedy introduction of the system to aid the health care facility's process improvement initiative.

Phase 1 402 shows the preliminary planning step of the system and method. In this step, a project charter may be created which defines what the project team will deliver, what resources are needed, and why it is justified. In the embodiment shown, the project charter can include a statement of the scope, objectives and participants in a project. It can provide a preliminary delineation of roles and responsibilities, outline project objectives, identify the main stakeholders, and define the authority of the project manager. It can, in some embodiments, serve as a reference of authority for the future of the project. In some embodiments, the project manager, the health care facility representative, and other individuals and the health care facility can create the project charter. In other embodiments, the project charter can be generated automatically by the system using user selected system parameters.

Phase 2 406 also includes a site survey and data gathering step. In this step, the installation and deployment team, such as the hardware, and sensing system experts can gather information on the site where the project will be implemented. Existing IT systems, networks and infrastructure are taken into account, including but not limited to, IT security, network access, projected impact to systems and networks, and user acceptance to the project. This site information is stored in the system. In the embodiment shown, an assessment is prepared and presented to the working group.

Phase 1 402 shows the process and requirements definition step. In this step, the current and future process parameters are identified. At this stage, the process transformation team's process transformation experts may identify the current hand hygiene compliance procedures, and determine the steps to be undertaken to transition from the current procedures to the next state compliance with the improved hand hygiene compliance procedure. The process transformation team can then gather data by observing the current procedures on-site and obtaining information from health care facility staff, so as to gather statistics regarding the compliance rates of the current hand hygiene process, as well as to define the desired future hand hygiene compliance process, and to identify metrics and compliance targets. This can be done using automated systems that collect the data such as systems described herein.

The process transformation team can examine the current hand hygiene procedures and practices with the health care facility staff, taking into consideration the layout of a particular health care facility area where implementation will be performed, the schedules of the staff, etc. The examination of hand hygiene procedures can, in some embodiments, be performed using automated systems and methods such as those described herein. Interviews can be conducted by the process transformation team with key users (doctors and health care workers) to identify an improved hand hygiene compliance process, from the current practice (next state). The process transformation team meets with health care facility staff to identify the precise location and times that hand hygiene is required, as well as to identify the method to be used to ensure that hand hygiene is performed in a way to benefit the patients. Interviews, in some embodiments can be conducted electronically with questions generated based on the data collected, and transmitted automatically such as over an internal computer network to a user work station, or, in other embodiments, via email, to HCWs, who then respond as requested.

Identification of the next state process determines how the system will be configured by the administrators and operators, and where the sensing network will be installed to ensure that data is appropriately and accurately captured and measured.

In the embodiment shown, after identification of the current and next state processes, the process transformation experts, along with the project manager and health care facility representative, can present the proposed process transformation for approval and authorization to proceed. Process improvement practitioners can facilitate the identification of additional steps in the “next state” process along with other health care facility requirements, such as additional data metrics to capture or particular locations of sensors, however, such additional steps can be performed using automated systems and methods such as those described herein.

Once the process transformation has been defined, the individual steps involving hand hygiene, monitored by the system, are identified by the process transformation experts incorporating lean and six sigma consulting services to map and improve processes, such as software and sensing devices, by defining events targeted for change. This includes the hand hygiene compliance rate which the health care facility has identified as its goal to achieve (compliance target), and these are entered in the system as a constant value. Persons of skill will understand that these parameters and targets may be computed by the system and automatically stored for use.

Phase 3 406 shows the system design definition and integration step of the system, in use. At this step, the implementation and deployment team, together with the health care facility representative, regularly meet to ensure that the system and software to be implemented at the health care facility site is properly designed to capture the data required to properly monitor the hand hygiene process. The meetings also ensure that there is proper integration between the requirements of the health care facility in terms of hand hygiene with the current and “next state” business process defined by the process transformation team.

In some embodiments, the installation and deployment team, in particular the software and hardware experts, with the third party sensing system installers, can prepare the sensing network design to ensure that data is properly captured and transmitted to the server computer, as well as create the steps for deployment of the hand hygiene compliance measuring procedures. The installation and deployment team, in particular the software experts, can prepare the design for the hand hygiene monitoring solution to be implemented at the health care facility. The design will incorporate the network design, and the configuration of the solution in accordance with the “next state” process agreed upon during the process and planning sessions.

Phase 2 404 shows the site setup step. At this step, the implementation and deployment team, particularly the software and hardware experts prepare the project site for installation. This includes set up of necessary hardware, such as servers and network connections, sensing system setup, such as location sensors, hand hygiene dispense sensors, and RFID tags, and software setup. The software expert can configure the system by inputting the “next state” process and defining the measuring points where hand hygiene data needs to be collected.

Phase 2 404 further shows the step of capturing hand hygiene data. In use, the hand hygiene compliance system, monitors and measures the compliance targets that were established in Phase 1 402. The system can incorporate three components for real-time and continuous monitoring of hand hygiene compliance processes: a software program, a process transformation, and a sensing system. In the embodiment shown, the hand hygiene compliance system is designed to track process flow and capture key metrics required for hand hygiene compliance. In use, the hand hygiene compliance system obtains location and hand hygiene dispense event information from the sensing system and determine compliance or non-compliance for a specific process step entered in the workflow. The compliance or non-compliance is, in the embodiment shown, recorded and acted on as configured in hand hygiene compliance system (including for example, the provision of messaging, alerts and reports for action. Hand hygiene event information can be compiled and an average can be computed (however, in some embodiments other appropriate computations can be performed). The information can be converted into a graph (or other visual display) which can then be displayed on various monitors or dashboards implemented in software, which are grouped according to various user types (such as health care facility administrators, health care staff, or staff belonging to a particular department).

In some embodiments, the dashboard is displayed on a monitor or other display device and can display some or all of the following information: a table comparing the overall hand hygiene rate with the target compliance rate; and a graph which displays the monthly hand hygiene compliance rate for a 12-month period as vertical graph, with a horizontal line indicating the overall compliance rate for the period. If other data measures are being gathered, these are also displayed on the dashboard.

In use, the hand hygiene compliance system information, displayed on the dashboard, can also be printed out as a report. Reports may be generated on a unit-level, department-level, or organization-level basis, depending on the access rights of the individual. Compliance reports can be generated on a real-time basis. Various time periods may also be used in generating the reports (day-to-day, week-on-week, or month-on-month).

In the embodiment shown, the data generated by the system is real-time data and actions can be taken to immediately rectify potential problems, such as a low rate of hand hygiene compliance in a particular health care facility unit or department. In some embodiments, alerts are set up to immediately remind staff to perform hand hygiene once an opportunity is missed. In some embodiments, continued non-performance of hand hygiene causes the system to generate additional reminders as well as an email to the staff or the health care facility administrator for appropriate action. In the embodiment shown, alerts are set up, configured and modified in the hand hygiene compliance system, based on user selected or system computed parameters.

Phase 2 406 further shows the step of assessment, whereby data from the hand hygiene compliance system is retrieved and six sigma methodology and lean philosophy is applied to the data. In this step, improvements to the “next state” process are prepared and discussed with the health care facility representative or the working group.

Once the “next state” process improvement has been identified, the hand hygiene compliance system is reconfigured, either automatically, or by the hand hygiene compliance system expert to reflect the changes in the process. In use, the health care facility's staff also starts to gain exposure to the system and its integration to the process improvement being implemented. Rather than simply monitoring compliance, the hand hygiene compliance system can provide for process transformation. The data gathering processes of the system are continually ongoing, and are used as a check to determine whether changing parameters and implemented improvements are assisting in achieving the system's compliance rate targets.

In use, automated information messaging, display systems or on-site information seminars may be initiated to inform on and train a group of the health care facility's staff to use the hand hygiene compliance systems and methods. These trainers can be responsible to train other staff within the health care facility as required, otherwise known as a train-the-trainer approach. Educational materials can be provided to the health care facility trainers such as user manuals and administrator guides on the use of hand hygiene compliance system, including how to use the software features, and basic troubleshooting and problem resolution. Staff are also taught how to interpret the reports displayed on the dashboards.

In use, the implementation and deployment team, in particular the hand hygiene compliance software and hardware experts, can conduct system testing and user acceptance testing, to ensure that the various components of the sensing system, such sensors and ID tags, function and communicate with each other, and integrate seamlessly into the computer equipment and hand hygiene compliance system. Once testing is complete, system hand-off is performed and the health care facility's team takes ownership of the system. In some implementations, support team are assigned to continually provide technical assistance when needed.

At Phase 3 406 the continued transformation step is shown where the trained health care facility staff monitor the real-time data, which permits the health care facility to continue to assess the behaviour change of the health care facility staff, as reflected by improved hand hygiene compliance.

After examining generated reports and comparing these with target compliance rates, further process improvement is undertaken to identify key problem areas, prepare and implement improved processes, and immediately monitor to determine if the improvements are effective in improving hand hygiene compliance. Six sigma, lean, or a combination of the two are among the various process improvement methodologies and tools which are used to take advantage of the real-time data and to permit improvements to the hand hygiene compliance procedures on an accelerated and on-going basis.

While the foregoing invention has been described in some detail for purposes of clarity and understanding, it will be appreciated by those skilled in the relevant arts, once they have been made familiar with this disclosure, that various changes in form and detail can be made without departing from the true scope of the invention in the appended claims. The invention is therefore not to be limited to the exact components or details of methodology or construction set forth above. Except to the extent necessary or inherent in the processes themselves, no particular order to steps or stages of methods or processes described in this disclosure, including the figures, is intended or implied. In many cases the order of process steps may be varied without changing the purpose, effect, or import of the methods described.

1. A system for controlling hand hygiene compliance in a health care environment, comprising:
at least one computer; and
a non-transitory computer-readable medium coupled to the at least one computers having instructions stored thereron which, when executed by the at least one computer, cause the at least one computer to perform operations comprising:
receiving hand hygiene compliance event data from at least one sensor associated with hand hygiene instruments in communication with an identification tag;
determining a rate of hand hygiene compliance by assessing the hand hygiene compliance event data against a target compliance rate;
determining at least one root cause associated with any rate of hand hygiene compliance determined as less than the target compliance rate;
determining at least one hand hygiene solution associated with each of the at least one root cause; and
providing the at least one hand hygiene solution to a health care worker associated with the health care environment.

2. The system of claim 1, wherein the determining rate of hand hygiene compliance further comprise assessing hand hygiene based on identification tags being identified by at least one of the sensors being associated with a locations identified as contaminated.

3. The system of claim 2, wherein the providing the at least one hand hygiene solution to a health care worker comprise providing an alert to the identification tag.

4. The system of claim 3, wherein the alert is an audiovisual warning.

5. The system of claim 2, wherein the providing the at least one hand hygiene solution to a health care worker comprise providing a message to a communication terminal of the health care worker.

6. The system of claim 5, wherein the communication terminal is a computer terminal and the message is an e-mail message.

7. The system of claim 5, wherein the communication terminal is a mobile telephone device.

8. The system of claim 7, wherein the message is one of a text message or an email message.

9. The system of claim 2, wherein the operations further comprise:
receiving further hand hygiene compliance event data from the at least one sensors, wherein the further hand hygiene compliance event data is associated with the identification tag after the at least one hand hygiene solution is provided to the health care worker;
determining a further rate of hand hygiene compliance by assessing the further hand hygiene compliance event data against the target compliance rate;
determining, if the further rate of hand hygiene compliance is less than the target compliance rate, another of the at least one hand hygiene solution and providing the another of the at least one hand hygiene solution to the health care worker.

10. The system of claim 9, wherein the determining of the at least one hand hygiene solution is based on application of Lean Six Sigma change in relation to the at least one root cause.

11. A computer implemented method for controlling hand hygiene compliance in a health care environment, comprising the steps of:
receiving hand hygiene compliance event data from at least one sensor associated with hand hygiene instruments in communication with an identification tag;
determining a rate of hand hygiene compliance by assessing the hand hygiene compliance event data against a target compliance rate;
determining at least one root cause associated with any rate of hand hygiene compliance determined as less than the target compliance rate;
determining at least one hand hygiene solution associated with each of the at least one root cause; and
providing the at least one hand hygiene solution to a health care worker associated with the health care environment.

12. The method of claim 11, wherein the step of determining a rate of hand hygiene compliance further comprises assessing hand hygiene based on identification tags being identified by at least one of the sensors being associated with a locations identified as contaminated.

13. The method of claim 12, wherein the step of providing the at least one hand hygiene solution to a health care worker comprises providing an alert to the identification tag.

14. The method of claim 13, wherein the alert is an audiovisual warning.

15. The method of claim 12, wherein the step of providing the at least one hand hygiene solution to a healthcare worker comprises providing a message to a communication terminal of the health care worker.

16. The method of claim 15, wherein the communication terminal is a computer terminal and the message is an e-mail message.

17. The method of claim 15, wherein the communication terminal is a mobile telephone device.

18. The method of claim 17, wherein the message is one of a text message or an email message.

19. The method of claim 12, further comprising the steps of:
receiving further hand hygiene compliance event data from the at least one sensor, wherein the further hand hygiene compliance event data is associated with the identification tag after the at least one hand hygiene solution is provided to the health care worker;
determining a further rate of hand hygiene compliance by assessing the further hand hygiene compliance event data against the target compliance rate; and
determining, if the further rate of hand hygiene compliance is less than the target compliance rate, another of the at least one hand hygiene solution and providing the another of the at least one hand hygiene solution to the health care worker.

20. The method of claim 19, wherein the step of determining at least one hand hygiene solution is based on application of Lean Six Sigma change in relation to the at least one root cause.
